(19) United States
(12) Patent Application Publication
(10) Pub. No.: US 2009/0011255 A1
(43) Pub. Date: Jan. 8, 2009

(54) Method for Producing Product Having Stain-Proofing Layer and Product Having Stain-Proofing Layer

(75) Inventors: Hidenori Komai, Nagano-ken (JP); Jun Kinoshita, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/278,258

(22) PCT Filed: Mar. 14, 2007
(86) PCT No.: PCT/JP2007/055792

§ 371 Date: Aug. 4, 2008

(30) Foreign Application Priority Data
Mar. 15, 2006 (JP) 2006-070692
Oct. 30, 2006 (JP) 2006-293631

(51) Int. Cl. B32B 9/00

(52) U.S. Cl. 428/447

(57) ABSTRACT

A production method, which is a production method for a product having a stain-proofing layer, containing a step of forming the stain-proofing layer by using a fluorine-containing composition on a surface of an organic anti-reflection layer which is a lower layer of the stain-reflection layer is provided. The fluorine-containing composition includes at least one type of fluorosilane compound selected from the group consisting of fluorosilane compounds each having a molecular weight in the range of from 1000 to 10000 and at least one type of fluorosilane compound selected from the group consisting of fluorosilane compounds each having a molecular weight in the range of from 100 to 700. By these arrangements, the stain-proofing layer having sufficient durability can be formed on the organic anti-reflection layer.

### TECHNICAL FIELD

The present invention relates to a lens and other products, a method for producing a product having a stain-proofing layer, and the product having the stain-proofing layer.

### BACKGROUND ART

An anti-reflection layer for controlling reflection is provided in a product in which reflection on a surface is not favorable such as a lens to be used in spectacles or the like or an optical disk. In the product provided with such anti-reflection layer, when the anti-reflection layer is fouled with, for example, hand-staining, a finger print, perspiration, or cosmetics, function of the anti-reflection layer is impaired. For this account, in the product having the anti-reflection layer, a stain-proofing layer having water-repellency is formed while overlaying on the anti-reflection layer in many cases.

In JP-A No. 2005-43572, it is described that a fluorine-based water-repellent film is formed on an outermost surface of an organic anti-reflection layer.

In JP-A No. 2005-3817, it is described that a stain-proofing layer is formed on a surface by using two or more kinds of silane compounds, including at least one or more kinds of fluorine-containing silane compounds, in which dynamic friction coefficients of lens surfaces to be defined when they are each individually used as a single component are different from one another.

As for such anti-reflection layers, an inorganic anti-reflection layer configured to have a multiple of inorganic layers having different refractive indices from one another is known. Further, application of an organic anti-reflection layer containing an organosilicon compound and silica type fine particles is under study. Therefore, it is important to provide a composition for forming a stain-proofing layer which covers an organic anti-reflection layer. It is questionable whether or not the composition having a same fluorine-containing silane compound as an inorganic anti-reflection layer is appropriate for an organic anti-reflection layer as it is and some cases in each of which durability is not sufficient are reported. It is required that the stain-proofing layer imparted with a function for protecting a surface of the anti-reflection layer is imparted with sufficient water repellency and durability.

### DISCLOSURE OF THE INVENTION

One aspect of the present invention is a production method for a product having a stain-proofing layer, in which, in the product having the stain-proofing layer, a lower layer of the stain-proofing layer is an organic anti-reflection layer and the production method has a step of forming the stain-proofing layer by using a fluorine-containing composition on a surface of the organic anti-reflection layer. The fluorine-containing composition includes a first component and a second component. The first component is at least one type of fluorosilane compound (fluorosilane compound A) selected from a first group consisting of fluorosilane compounds each having a molecular weight in the range of from 1000 to 10000. The second component is at least one type of fluorosilane compound (fluorosilane compound B) selected from a second group consisting of fluorosilane compounds each having a molecular weight in the range of from 100 to 700.

According to tests executed by the present inventors, it has been found that the fluorine-containing composition including the first component and the second component (the fluorine-containing composition including at least two types of fluorosilane compounds (fluorosilane compound A and fluorosilane compound B)) is capable of forming a stain-proofing layer imparted with sufficient water repellency and durability on an organic anti-reflection layer depending on the ratio of a content of the first component to that of the second component (ratio of the content of the fluorosilane compound A to the content of the fluorosilane compound B).

A favorable range of the ratio of the weight Wa of the first component (fluorosilane compound A) to the weight Wb of the second component (fluorosilane compound B) which are included in the fluorine-containing composition capable of forming the stain-proofing layer imparted with sufficient water repellency and durability is such a range as satisfies the following condition:

90/10≧Wa/Wb≧30/70 (1).

It is more preferable that the ratio of the weight Wa of the first component to the weight Wb of the second component satisfies the following condition:

80/20≧Wa/Wb≧50/50 (2).

The first component (at least one type of fluorosilane compound A selected from fluorosilane compounds each having a molecular weight in the range of from 1000 to 10000) typically includes a fluorosilane compound (fluorosilane compound C) represented by the general formula (I) described below and/or a fluorosilane compound (fluorosilane compound D) represented by the general formula (II) described below.

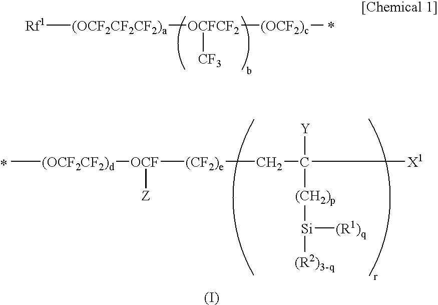

In the formula (I), Rf¹ represents a perfluoroalkyl group;

Z represents fluorine or a trifluoromethyl group;

a, b, c, d and e each independently represent an integer of 0, or 1 or more;

a+b+c+d+e represents at least 1, in which the order of respective repeating units represented by a, b, c, d and e is not particularly limited in the formula;

Y represents hydrogen or an alkyl group having from 1 to 4 carbon atoms;

X¹ represents hydrogen, bromine or iodine;

R¹ represents a hydroxyl group or a hydrolyzable substituent;

R² represents hydrogen or a monovalent hydrocarbon group;

p represents 0, 1 or 2;

q represents 1, 2 or 3; and

r represents an integer of 1 or more.

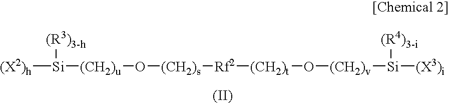

In the formula (II), Rf² represents a divalent group which comprises a unit represented by the formula:

—(CₖF₂ₖ)O—, (in the formula, k represents an integer of from 1 to 6) and a straight-chain perfluoropolyalkylene ether structure having no branch;

R³ and R⁴ each independently represent a monovalent hydrocarbon group having from 1 to 8 carbon atoms;

X² and X³ each independently represent a hydrolyzable group or a halogen atom;

s and t each independently represent an integer of from 0 to 2;

u and v each independently represent an integer of from 1 to 5; and

h and i each independently represent 2 or 3.

A favorable organic anti-reflection layer includes an organosilicon compound (E component) represented by the general formula (III) described below and silica fine particles (F component).

R⁵ₘR⁶ₙSiX⁴₄₋ₙ₋ₘ (III).

In the formula (III), R⁵ represents an organic group having a polymerizable reactive group;

R⁶ represents a hydrocarbon group having from 1 to 6 carbon atoms;

X⁴ represents a hydrolyzable group;

at least one of m and n represents 1 and the other represents 0 or 1.

Another aspect of the invention is a product having a stain-proofing layer, in which a lower layer of the stain-proofing layer is an organic anti-reflection layer and the stain-proofing layer is formed of a fluorine-containing composition. The fluorine-containing composition includes a first component and a second component. The first component is at least one type of fluorosilane compound (fluorosilane compound A) selected from the first group consisting of fluorosilane compounds each having a molecular weight in the range of from 1000 to 10000. The second component is at least one type of fluorosilane compound (fluorosilane compound B) selected from the second group consisting of fluorosilane compounds each having a molecular weight in the range of from 100 to 700.

### BRIEF DESCRIPTION OF THE DRAWINGS

TABLE 1. is a table showing production conditions for a stain-proofing layer according to an embodiment of the present invention and evaluation results.

### BEST MODE FOR CARRYING OUT THE INVENTION

A fluorine-containing composition appropriate for forming a stain-proofing layer on a surface of an organic anti-reflection layer includes a first component (at least one fluorosilane compound A selected from fluorosilane compounds having a molecular weight in the range of from 10000 to 10000) and a second component (at least one fluorosilane compound B selected from fluorosilane compounds having a molecular weight in the range of from 100 to 700). A favorable range of ratio of a weight Wa of the first component (fluorosilane compound A) to a weight Wb of the second component (fluorosilane compound B) is such a range as satisfies the condition described below.

90/10≧Wa/Wb≧30/70 (1).

It is more preferable that the ratio of the weight Wa of the first component to the weight Wb of the second component satisfies the condition described below.

80/20≧Wa/Wb≧50/50 (2).

These ranges are such ranges as confirmed by tests executed by the present inventors as described below.

Against an inorganic anti-reflection layer, a stain-proofing layer is formed by using a fluorosilane compound having a molecular weight of from 2000 to 3000 in many cases. Against an organic anti-reflection layer, when same application is performed, there are some cases in which sufficient durability may not be obtained. It is considered that this is caused by the fact that, compared with the case in which the inorganic anti-reflection layer is formed by a dense oxide film, a surface condition of the organic anti-reflection layer is rough and density of active hydrogen group of the surface is low. Namely, when the density of the active hydrogen group of the surface is low, a space for bonding by the active hydrogen group between the component of the anti-reflection film and the component of the stain-proofing layer comes to be wider and, as a result, it is considered that it becomes hard to form a bonding between the component of the anti-reflection layer and the component of the stain-proofing layer, strength of the stain-proofing layer in a horizontal direction is decreased and, then, durability is lowered.

It is considered that, by forming the stain-proofing layer by using the fluorosilane compound having a small molecular weight, adhesion with the surface of the organic anti-reflection layer can be increased. However, from a reason that strength itself of the stain-proofing layer is decreased or some other reason, a favorable result has not been obtained. It is considered to the contrary that, by allowing the molecular weight to be larger, for example, by forming the stain-proofing layer by means of using the fluorosilane compound having a molecular weight of 10000 or more, the strength of the stain-proofing layer can be enhanced. However, such aspect as described above did not generate a good result. Further, in the case of the molecular weight of 10000 or more, since a viscosity is increased and solubility is lowered along with the increase of the molecular weight, there is a problem in that the stain-proofing layer is hard to be industrially used.

Under these circumstances, it has been found that, so long as the fluorosilane compound contains at least one type of fluorosilane compound selected from the first group consisting of the fluorosilane compounds each having a high molecular weight, namely, a molecular weight in the range of from 1000 to 10000 (first component; fluorosilane compound A) and at least one type of fluorosilane compound selected from the second group consisting of the fluorosilane compounds each having a low molecular weight, namely, a molecular weight in the range of from 100 to 700 (second component; fluorosilane compound B), the fluorosilane compound can form the stain-proofing layer imparted with sufficient durability also against the organic anti-reflection layer by containing the first component (fluorosilane compound of high molecular weight) and the second component (fluorosilane compound of low molecular weight) at an appropriate ratio there between. A factor in which the durability is enhanced by the composition containing a plurality of fluorosilane compound having different molecular weights from one another is considered as below.

Namely, when the surface condition of the organic anti-reflection layer is rough (irregularity is large, and there are a mountain face (mountain portion; concave portion) and a valley face (valley portion; convex portion)), it is considered that the fluorine-containing compound containing only the first component (the compound having a high molecular weight) can combine with the mountain face of the surface but can not infiltrate into the valley face. Or, it is considered that a space is present between clusters of the thus combined first component (compound having a high molecular weight) and a sufficient stain-proofing performance can not be obtained. Further, it is considered that, although the fluorine-containing compound containing only the second component (compound having a low molecular weight) can combine with both the mountain face and the valley face, the stain-proofing performance is not sufficient.

Contrarily to these arrangements, by combining the first component (compound having a high molecular weight) and the second component (compound having a low molecular weight), the stain-proofing layer can uniformly be formed on the surface of the organic anti-reflection layer. When the molecular weight of the second component (compound having a low molecular weight) is 700 or more, the fluorine-containing compound can not infiltrate into the valley face of the surface and an effect to be expected as the second component (fluorosilane compound B having a low molecular weight) can not be obtained. On the other hand, when the molecular weight of the first component (compound having a high molecular weight) is less than 1000, the stain-proofing performance is insufficient and an effect to be expected as the first component (fluorosilane compound A having a high molecular weight) can not be obtained.

An example of the first component (fluorosilane compound A having a high molecular weight) is a fluorosilane compound represented by the general formula (I) described below. Such fluorosilane compounds represented by the general formula (I) include “OPTOOL DSX” (trade name; manufactured by Daikin Industries, Ltd.).

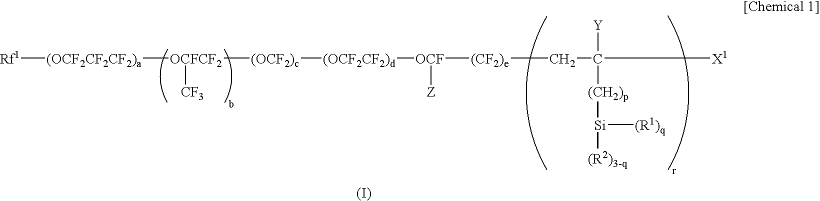

In the general formula (I), Rf¹ represents a perfluoroalkyl group; Z represents fluorine or a trifluoromethyl group; a, b, c, d and e each independently represent an integer of 0, or 1 or more; a+b+c+d+e represents at least 1, in which the order of respective repeating units represented by a, b, c, d and e is not particularly limited in the formula; Y represents hydrogen or an alkyl group having from 1 to 4 carbon atoms; X¹ represents hydrogen, bromine or iodine; R¹ represents a hydroxyl group or a hydrolyzable substituent; R² represents hydrogen or a monovalent hydrocarbon group; p represents 0, 1 or 2; q represents 1, 2 or 3; and r represents an integer of 1 or more.

Rf¹ in the formula represented by the general formula (I) is not particularly limited, so long as it is a perfluoroalkyl group constituting an organic fluorine-containing polymer. As for Rf¹, for example, a straight-chain or a branched-chain perfluoroalkyl group having from 1 to 16 carbon atoms can be mentioned. Rf¹ preferably represents CF₃—, C₂F₅— or C₃F₇—.

Z in the general formula (I) may be fluorine or trifluoromethyl group. a, b, c, d and e in the general formula (I) each represent a repeating unit of a perfluoropolyether chain constituting a main skeleton of a fluorosilane compound and each independently represents an integer of 0, or 1 or more. Although a, b, c, d and e are not particularly limited, so long as a+b+c+d+e is 1 or more, they preferably each independently represent from 0 to 200. Further, when the molecular weight of the fluorosilane compound is taken into consideration, a, b, c, d and e more preferably each independently represent from 0 to 50. a+b+c+d+e preferably represents 1 to 100. Further, the order of respective repeating units represented by a, b, c, d and e is described in the stated order in the general formula (I); however, within the range of the constitution of the ordinary perfluoropolyether chain, a combining order of these respective repeating units is not limited to the stated order.

Y in the general formula (I) represents hydrogen or an alkyl group having from 1 to 4 carbon atoms. The alkyl group having from 1 to 4 carbon atoms is not particularly limited and, for example, a methyl group, an ethyl group, a propyl group and a butyl group can be mentioned. The alkyl group having from 1 to 4 carbon atoms may be in a straight-chain state or a branched-chain state. X¹ in the general formula (I) represents hydrogen, bromine or iodine. When X¹ represents bromine or iodine, the fluorosilane compound represented by the general formula (I) becomes high in radical reactivity. Therefore, it is convenient to allow it to be chemically bonded with any other compound.

p in the general formula (I) represents the number of carbon atoms of an alkylene group existing between the carbon constituting the perfluoropolyether chain and silicon to be combined therewith and it is preferably 0, 1 or 2 and, more preferably, 0.

q in the general formula (I) represents the number of bonds of substituent R¹ combined with silicon and the number is preferably 1, 2 or 3. In a portion in which R¹ is not combined, R² is combined with silicon.

R¹ represents a hydroxyl group or a hydrolyzable substituent. The hydrolyzable substituent is not particularly limited and examples of preferable such hydrolyzable substituents include a halogen, —OR¹¹, —OCOR¹¹, —OC(R¹¹)═C(R¹²)₂, —ON═C(R¹¹)₂, and —ON═CR¹³. On this occasion, R¹¹ represents an aliphatic hydrocarbon group or an aromatic hydrocarbon group; R¹² represents hydrogen or an aliphatic hydrocarbon group having from 1 to 4 carbon atoms; R¹³ represents a divalent aliphatic hydrocarbon group having from 3 to 6 carbon atoms. More preferably, R¹ represents chlorine, —OCH₃ or OC₂H₅.

R² represents hydrogen or a monovalent hydrocarbon group. The monovalent hydrocarbon group is not particularly limited and examples of preferable such monovalent hydrocarbon groups include a methyl group, an ethyl group, a propyl group or a butyl group. The monovalent hydrocarbon group may be in a straight-chain state or a branched-chain state.

r in the general formula (I) represents an integer of 1 or more. Although there is no upper limit in r, an integer of 1 to 10 is preferred. Although r represents an integer in the general formula (I), a fluorosilane compound which is represented by the general formula (I) and is contained in the first component may be a mixture of a polymer which is represented by the general formula (I) having such integer r as described above. Therefore, when an average composition is shown by an expression similar to the general formula (I) the value of r or the like in the formula is not limited to integers. Same can be said not only with other values which are defined as being integers but also with values which are defined as being integers in other formulas.

Another example of the first component (fluorosilane compound A having a high molecular weight) is a fluorosilane compound (perfluoropolyalkylene ether-modified silane) represented by the general formula (II) described below. Examples of fluorosilane compounds represented by the general formula (II) include “KY-130” (trade name; manufactured by Shin-Etsu Chemical Co., Ltd.).

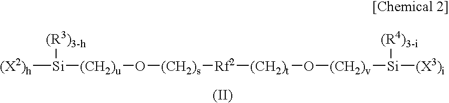

In the general formula (II), Rf² represents a divalent group which contains a unit represented by —(CₖF₂ₖ)O— (in the formula, k represents an integer of from 1 to 6) and a straight-chain perfluoropolyalkylene ether structure having no branch; R³ and R⁴ each independently represent a monovalent hydrocarbon group having from 1 to 8 carbon atoms; X² and X³ each independently represent a hydrolyzable group or a halogen atom; s and t each independently represent an integer of from 0 to 2; u and v each independently represent an integer of from 1 to 5; and h and i each independently represent 2 or 3.

Rf² in the general formula (II), as described above, represents a divalent group which contains a unit represented by the formula: —(CₖF₂ₖ)O— (in the formula, k represents an integer of from 1 to 6 and, preferably, from 1 to 4) and a straight-chain perfluoropolyalkylene ether structure having no branch. Further, when s and t in the general formula (II) each independently represent 0, a terminal of Rf² which is combined with an oxygen atom in the general formula (II) is not an oxygen atom.

As for Rf², for example, articles represented by the general formula described below can be mentioned; however, Rf² is not limited to those illustrated below.

—CF₂CF₂O(CF₂CF₂CF₂O)ⱼCF₂CF₂— (in the formula, j represents an integer of 1 or more, preferably from 1 to 50 and, more preferably, from 10 to 40); —CF₂(OC₂F₄)p′-(OCF₂)q′- (in the formula, p′ and q′ each independently represent an integer of 1 or more, preferably from 1 to 50 and, more preferably, from 10 to 40; p′+q′ represents an integer of from 10 to 100, preferably from 20 to 90 and, more preferably, from 40 to 80; and arrangements of (OC₂F₄) and (OCF₂) are performed at random.)

When X² and/or X³ in the general formula (II) is a hydrolyzable group, examples of X² and/or X³ include alkoxy groups such as a methoxy group, an ethoxy group, a propoxy group and a butoxy group; alkoxyalkoxy groups such as a methoxymethoxy group, a methoxyethoxy group and an ethoxyethoxy group; alkenyloxy groups such as an allyloxy group and an isopropenoxy group; acyloxy groups such as an acetoxy group, a propionyloxy group, a butyl carbonyloxy group and a benzoyloxy group; ketoxime groups such as a dimethyl ketoxime group, a methyl ethyl ketoxime group, a diethyl ketoxime group, a cyclopentanoxime group and a cyclohexanoxime group; amino groups such as an N-methylamino group, an N-ethylamino group, an N-propylamino group, an N-butylamino group, an N,N-dimethylamino group, an N,N-diethylamino group and an N-cyclohexylamino group; amide groups such as an N-methylacetamide group, an N-ethylacetamide group and an N-methylbenzamide group; and aminoxy groups such as an N,N-dimethylaminoxy group and an N,N-diethylaminoxy group.

Further, when X² and/or X³ is a halogen atom, examples thereof include a chlorine atom, a bromine atom and an iodine atom. Among these halogens, as for X² and X³, a methoxy group, an ethoxy group, an isopropenoxy group and a chlorine atom are preferred.

R³ and R⁴ in the general formula (II) each independently represent a hydrocarbon group having from 1 to 8 carbon atoms and, preferably, from 1 to 3 carbon atoms. Examples of R³ and R⁴ include alkyl groups such as a methyl group, an ethyl group, a propyl group, a butyl group, a pentyl group, a hexyl group, a heptyl group and an octyl group; cycloalkyl groups such as a cyclopentyl group and a cyclohexyl group; aryl groups such as a phenyl group, a tolyl group and a xylyl group; aralkyl groups such as a benzyl group and a phenethyl group; and alkenyl groups such as a vinyl group, an allyl group, a butenyl group, a pentenyl group and a hexenyl group. Among these groups, as for R³ and R⁴, a methyl group is preferred.

s and t in the general formula (II) each independently represent an integer of from 0 to 2 and, preferably, 1. u and v in the general formula (II) each independently represent an integer of from 1 to 5 and, preferably, 3. h and i each independently represent 2 or 3 and, from the view point of reactivity of hydrolysis and condensation and adhesiveness of a film, preferably, 3.

In a group (second group) of fluorosilane compounds each having a low molecular weight (the molecular weight is in a range of from 100 to 700), for example, 3,3,3-trifluoropropyltrimethoxysilane, tridecafluorooctyltrimethoxysilane, heptadecafluorodecyltrimethoxysilane, n-trifluoro(1,1,2,2-tetrahydro)propylsilazane, n-heptafluoro(1,1,2,2-tetrahydro)pentylsilazane, n-nonafluoro(1,1,2,2-tetrahydro)hexylsilazane, n-tridecafluoro(1,1,2,2-tetrahydro)octylsilazane, n-heptadecafluoro(1,1,2,2-tetrahydro)decylsilazane, octadecyltriethoxysilane, octadecyltrimethoxysilane, phenyltriethoxysilane, phenyltrimethoxysilane, heptylmethyldichlorosilane, isobutyltrichlorosilane, octadecylmethyldimethoxysilane and hexamethyldisilazane are contained.

Further, in the group (second group) of fluorosilane compounds each having a low molecular weight (the molecular weight is in the range of from 100 to 700), commercially available products with trade names such as KP-801, LS-1090, LS-4875, LS-4480, LS-2750, LS-1640, LS-410 and LS-7150 (all being manufactured by Shin-Etsu Chemical Co., Ltd.) and TSL-8257, TSL-8233, TSL-8185, TSL-8186, TSL-8183 and XC95-A9715 (all being manufactured by GE Toshiba Silicones Co., Ltd.) are contained.

In the products in the first embodiment according to the invention, an example of the organic anti-reflection layer contains the organosilicon compound (E component) represented by the general formula (III) described below and silica fine particles (F component).

R⁵ₘR⁶ₙSiX⁴₄₋ₙ₋ₘ (III).

In the general formula (III), R⁵ represents an organic group having a polymerizable reactive group; R⁶ represents a hydrocarbon group having from 1 to 6 carbon atoms; X⁴ represents a hydrolyzable group; and at least one of m and n represents 1 and the other represents 0 or 1.

R⁵ in the general formula (III) represents an organic group having a polymerizable reactive group and examples of such R⁵ include a vinyl group, an ally group, an acrylic group, a methacrylic group, an epoxy group, a mercapto group, a cyano group and an amino group. R⁶ in the general formula (III) represents a hydrocarbon group having from 1 to 6 carbon atoms and examples of such R⁶ include a methyl group, an ethyl group, a butyl group, a vinyl group and a phenyl group. X⁴ of the organosilicon compound of the E component represents a polymerizable functional group and examples of such X⁴ include alkoxy groups such as a methoxy group, an ethoxy group, a methoxyethoxy group, halogen groups such as a chloro group and a bromo group, and an acyloxy group.

Specific examples of organosilicon compounds (E compounds) represented by the general formula (III) above include tetramethoxysilane, a vinyltrialkoxysilane, vinyltrichlorosilane, vinyltri(β-methoxy-ethoxy)silane, an allytrialkoxysilane, an acryloxypropyltrialkoxysilane, a methacryloxypropyltrialkoxysilane, a methacryloxypropyldialkoxysilane, a γ-glycidoxypropyltrialkoxysilane, a β-(3,4-epoxycyclohexyl)-ethylrialkoxysilane, a mercaptopropyltrialkoxysilane, a γ-aminopropyltrialkoxysilane, an N-β(aminoethyl)-γ-aminopropylmethyldialkoxysilane and a tetraalkoxysilane.

Specific examples of silica type fine particles (F component) include a silica sol in which fine particles of silica having an average diameter of from 1 nm to 100 nm are dispersed in a colloidal state. As for dispersing media, water, alcohol types, or any other organic solvents and the like can be used.

These silica type fine particles preferably have inner voids (spaces). By using the silica type fine particles having inner voids, a refractive index of the anti-reflection layer can be reduced. Therefore, by allowing the difference between the refractive index of the anti-reflection layer and that of the hardcoat layer to be large, an anti-reflection effect can be enhanced. By allowing a gas or a solvent which has a lower refractive index than that of silica to be included in the inner voids of the silica type fine particles, the refractive index thereof becomes lower than that of the silica type fine particles having no void, to thereby attain a lower refractive index of the film.

Further, the organic type anti-reflection film may contain not only any one of the organosilicon compounds (E component) represented by the general formula (III) and silica type fine particles (F component) but also any one of various types of resins such as a polyurethane type resin, an epoxy type resin, a melamine type resin, a polyolefin type resin, a urethane acrylate type resin and an epoxy acrylate resin, anyone of various types of monomers, which become raw materials of these resins, such as methacrylates, acrylates, epoxys and vinyls. As for articles which each have a function of reducing the refractive index, various types of fluorine-containing polymers or various types of fluorine-containing monomers can be mentioned. Such fluorine-containing polymer is preferably a polymer which is produced by polymerizing a fluorine-containing vinyl monomer and, more preferably, has a functional group which is copolymerizable with any other component.

### EXAMPLES

Hereinafter, as an example of a product having an organic anti-reflection layer and a stain-proofing layer, a plastic lens for spectacles was produced and, then, the stain-proofing layers of several compositions were each formed on a surface of the organic anti-reflection layer and, thereafter, durability and the like thereof were examined.

The plastic lens in the embodiment described below was produced by using a lens substrate, a primer layer, a hardcoat layer, an organic anti-reflection layer and a stain-proofing layer in the stated order.

As for the lens substrate, a plastic lens substrate having a refractive index of 1.67 (manufactured by Seiko Epson Corp.; trade name: “Seiko Super Sovereign”) was used.

The primer layer was formed by applying a coating solution described below on the lens substrate. Firstly, 77 g of a commercially-available water-based polyester “A-160P” (solid content concentration: 25%; manufactured by Takamatsu Oil & Fat Co., Ltd.), 220 g of methanol, 31.5 g of propylene glycol monomethyl ether (PGME), 91.8 g of water, 78.8 g of a methanol-dispersed titanium dioxide-zirconium dioxide-silicon dioxide composite fine particle sol (solid content concentration: 20% by weight; manufactured by Catalysts & Chemicals Industries Co., Ltd.) and 0.1 g of a silicone type surfactant (manufactured by Nippon Unicar Co., Ltd.; trade name: “L-7604”) were mixed with one another and, then, the resultant mixture was stirred for 2 hours. For such application, a dipping method (pulling up speed: 20 cm/minute) was used and a substrate lens coated with the coating solution for forming the primer layer was subjected to a heat-hardening treatment for 20 minutes at 80° C. The thus-produced primer layer had a thickness of 0.5 μm and a refractive index of 1.67.

The hardcoat layer was formed by applying a coating solution described below on the primer layer. Firstly, 62.5 g of butyl cellosolve and 67.1 g of γ-glycidoxypropyltrimethoxysilane were mixed with each other. To the resultant mixture, 30.7 g of 0.1N aqueous solution of hydrochloric acid was added dropwise while stirring and, further, stirred for 4 hours and left to stand for one full day to be matured. To the resultant solution, 325 g of a methanol-dispersed titanium dioxide-zirconium dioxide-silicon dioxide composite fine particle sol (solid content concentration: 20% by weight; manufactured by Catalysts & Chemicals Industries Co., Ltd.), and 12.5 g of a glycelol diglycidyl ether (manufactured by Nagase ChemteX Corp.; trade name: “Denacol EX-313”) were added and, then, 1.36 g of iron(III)acetylacetonate, 0.15 g of a silicone type surfactant (manufactured by Nippon Unicar Co. Ltd.; trade name: “L-7001”) and 0.63 g of a phenol type anti-oxidant (manufactured by Kawaguchi Chemical Industry Co., Ltd.; trade name: “Antagecrystal”) were added and, thereafter, the resultant mixture was stirred for 4 hours and left to stand for one full day to be matured. For such application, a dipping method (pulling up speed: 35 cm/minute) was used. After the coating solution for forming the hardcoat layer was applied, the thus-coated coating solution was subjected to a heat-hardening treatment for 30 minutes at 8° C. and, thereafter, further subjected to a heat-hardening treatment for 180 minutes at 125° C. The hardcoat layer thus formed had a film thickness of 2.0 μm and a refractive index of 1.67.

The organic anti-reflection layer was formed by applying a coating solution described below on the hardcoat layer. Firstly, 48.6 g of propylene glycol monomethyl ether (hereinafter, referred to also as “PGME”), 14.1 g of γ-glycidoxypropyltrimethoxysilane were mixed with each other. To the resultant mixture, 4.0 g of 0.1N aqueous solution of hydrochloric acid was added dropwise while stirring and, further, stirred for 5 hours. To the resultant solution, 33.3 g of an isopropanol-dispersed hollow silica sol (average particle diameter: 91 nm; solid content concentration: 30% by weight) was added and thoroughly mixed and, then, 0.06 μg of Al(C₅H₇O₂)₃ as a curing catalyst and 0.03 g of a silicone type surfactant (manufactured by Nippon Unicar Co., Ltd.; trade name: “L7604”) were added, stirred and allowed to be dissolved therein, to thereby obtain a coating mother liquid having a solid content concentration of 20%. In order to dilute this coating mother liquid, a PGME solution containing a silicone type surfactant having a concentration of 300 ppm (manufactured by Nippon Unicar Co., Ltd.; trade name: “L7604”) was prepared. Then, 35.3 g of the coating mother liquid and 114.7 g of the PGME solution containing the surfactant for dilution were mixed with each other and sufficiently stirred, to thereby produce a coating solution having a solid content concentration of about 4.7% for forming an anti-reflection layer. Application was performed by using a dipping method in which a pulling up speed was set to be 10 cm/minute and a temperature of the coating solution was set to be 25° C. After the coating solution for forming the anti-reflection layer was applied, the thus-applied coating solution was subjected to annealing for 90 minutes at 125° C., to thereby form an organic anti-reflection layer having a thickness of about 91 nm and a refractive index of about 1.42.

An article in which the primer layer, the hardcoat layer and the organic anti-reflection layer were formed on the lens substrate is called as a workpiece.

### Experiment Example 1

By using a fluorine-containing composition SI, a stain-proofing layer was formed on the surface of the organic anti-reflection layer of the above-described workpiece. The fluorine-containing composition S1 which contained a fluorosilane compound A having a molecular weight of 2500 (manufactured by Shin-Etsu Chemical Co., Ltd.; trade name: “KY-130”) (hereinafter, referred to also as “compound A1”) and a fluorosilane compound B having a molecular weight of 497.5 (manufactured by Shin-Etsu Chemical Co., Ltd.; trade name: “KP-801”) (hereinafter, referred to also as “compound B1”) was prepared as a solution having a solid content concentration of 3% by being diluted with a fluorine type solvent (manufactured by Sumitomo 3M Limited; trade name: “Novec HFE-7200”). 6 types of fluorine-containing compositions S1 which have each different ratio of the weight Wa of the fluorosilane compound A1 to the weight Wb of the fluorosilane compound B1 from one another, namely, 90/10 (for example, compound A1 is 2.7% and compound B1 is 0.3% each as a solid content concentration when diluted in the solvent), 80/20 (compound A1 is 2.4% and compound B1 is 0.6%), 50/50 (compound A1 is 1.5% and compound B1 is 1.5%), 30/70 (compound A1 is 0.9% and compound B1 is 2.1%), 100/0 (compound A1 is 3% and compound B1 is 0%), and 20/80 (compound A1 is 0.6% and compound B1 is 2.4%) were prepared and a stain-proofing layer was formed by using each of the fluorine-containing compositions S1.

In Experiment Example 1, the stain-proofing layer was formed by using a dry (vapor deposition) method. Namely, porous ceramic pellets which were impregnated with 1 g of the fluorine-containing composition S1 and, then, dried were set in a chamber of a vacuum depositing unit as a depositing source. An inside of the chamber of the unit was evacuated until a pressure in the range of from 1.0 to 4.0×10⁻² Pa was attained. Into the inside of the chamber of the vacuum depositing unit, the above-mentioned workpiece was introduced and, then, the silane compounds were evaporated by heating the pellets to from 400° C. to 500° C., to thereby form a layer of the fluorine-containing composition S1 which becomes the stain-proofing layer on the organic anti-reflection layer. After deposition is terminated, the inside of the deposition unit was gradually returned to an atmospheric pressure and the workpiece with the fluorine-containing composition S1 deposited thereon was taken out and, then, the thus-taken out workpiece was put in a constant temperature and constant humidity chamber set at 90° C. 90% RH and held for 2 hours, to thereby obtain a plastic lens provided with the stain-proofing layer.

### Experiment Example 2

By using a fluorine-containing composition S2, a stain-proofing layer was formed on the surface of the organic anti-reflection layer of the above-described workpiece. The fluorine-containing composition S2 which contained the compound A1, namely, a fluorosilane compound having a molecular weight of 2500 and the compound B1, namely, a fluorosilane compound having a molecular weight of 497.5 was prepared as a solution having a solid content concentration of 0.3% by being diluted with a fluorine type solvent (manufactured by Sumitomo 3M Limited; trade name: “Novec HFE-7200”). Therefore, the fluorine-containing composition S2 is fundamentally same as the fluorine-containing composition S1. 6 types of the fluorine-containing compositions S2 which have each different ratio of the weight Wa of the fluorosilane compound A1 to the weight Wb of the fluorosilane compound B1 from one another, namely, 90/10 (compound A1 is 0.27% and compound B1 is 0.03% each as a solid content concentration when diluted in the solvent), 80/20 (compound A is 0.24% and compound B1 is 0.06%), 50/50 (compound A1 is 1.5% and compound B1 is 1.5%), 30/70 (compound A1 is 0.09% and compound B1 is 0.21%), 100/0 (compound A1 is 0.3% and compound B1 is 0%), and 20/80 (compound A1 is 0.06% and the compound B1 is 0.24%) were also prepared and the stain-proofing layer was formed by using each of the fluorine-containing compositions S2.

In Experiment Example 2, the stain-proofing layer was formed by using a wet (dipping) method. Namely, the workpiece was dipped in the fluorine-containing composition S2 and held therein for one minute and, then, pulled up at a speed of 15 cm/minute and, thereafter, put in a constant temperature and constant humidity chamber set at 90° C. 90% RH and held therein for 1.5 hour.

### Experiment Example 3

By using a fluorine-containing composition S3, a stain-proofing layer was formed on the surface of the organic anti-reflection layer of the above-described workpiece. The fluorine-containing composition S3 which contained a fluorosilane compound A having a molecular weight of 5000 (manufactured by Daikin Industries, Ltd.; trade name: “OPTOOL DSX”) (hereinafter, referred to also as “compound A2”) and a fluorosilane compound B1 having a molecular weight of 497.5 was prepared as a solution having a solid content concentration of 0.3% by being diluted with a fluorine type solvent (manufactured by Sumitomo 3M Limited; trade name: “Novec HFE-7200”). 6 types of fluorine-containing compositions S3 which have each different ratio of the weight Wa of the fluorosilane compound A2 to the weight Wb of the fluorosilane compound B1 from one another, namely, 90/10, 80/20, 50/50, 30/70, 100/0, and 20/80 were also prepared and the stain-proofing layer was formed by using each of the fluorine-containing compositions S3.

In Experiment Example 3, the stain-proofing layer was formed by using a wet (dipping) method. Conditions were same as in Experiment Example 2.

### Experiment Example 4

By using a fluorine-containing composition S4, a stain-proofing layer was formed on the surface of the organic anti-reflection layer of the above-described workpiece. The fluorine-containing composition S4 which contained a fluorosilane compound A having a molecular weight of 1000 (hereinafter, referred to also as “compound A3”) and a silane compound B having a molecular weight of 652 (manufactured by GE Toshiba Silicone Co., Ltd.; trade name: “XC95-A9715”) (hereinafter, referred to also as “compound B2”) was prepared as a solution having a solid content concentration of 0.3% by being diluted with a fluorine type solvent (manufactured by Sumitomo 3M Limited; trade name: “Novec HFE-7200”). 6 types of fluorine-containing compositions S4 which have each different ratio of the weight Wa of the fluorosilane compound A3 to the weight Wb of the fluorosilane compound B2 from one another, namely, 90/10, 80/20, 50/50, 30/70, 100/0, and 20/80 were also prepared and the stain-proofing layer was formed by using each of the fluorine-containing compositions S4.

In Experiment Example 4, the stain-proofing layer was formed by using a wet (dipping) method. Conditions were same as in Experiment Example 2.

### Experiment Example 5

By using a fluorine-containing composition 5, a stain-proofing layer was formed on the surface of the organic anti-reflection layer of the above-described workpiece. The fluorine-containing composition S5 which contained a fluorosilane compound A having a molecular weight of 10000 (hereinafter, referred to also as “compound A4”) and a silane compound B2 having a molecular weight of 652 was prepared as a solution having a solid content concentration of 0.3% by being diluted with a fluorine type solvent (manufactured by Sumitomo 3M Limited; trade name: “Novec HFE-7200”). 6 types of fluorine-containing compositions S5 which have each different ratio of the weight Wa of the fluorosilane compound A4 to the weight Wb of the fluorosilane compound B2 from one another, namely, 90/10, 80/20, 50/50, 30/70, 100/0, and 20/80 were also prepared and the stain-proofing layer was formed by using each of the fluorine-containing compositions S5.

In Experiment Example 5, the stain-proofing layer was formed by using a wet (dipping) method. Conditions were same as in Experiment Example 2.

### Experiment Example 6

By using a fluorine-containing composition S6, a stain-proofing layer was formed on the surface of the organic anti-reflection layer of the above-described workpiece. The fluorine-containing composition S6 which contained a fluorosilane compound A4 having a molecular weight of 10000 and a silane compound B having a molecular weight of 116.2 (manufactured by Shin-Etsu Chemical Co., Ltd.; trade name: “LS805”) (hereinafter, referred to also as “compound B3”) was prepared as a solution having a solid content concentration of 0.3% by being diluted with a fluorine type solvent (manufactured by Sumitomo 3M Limited; trade name: “Novec HFE-7200”). 6 types of fluorine-containing compositions S6 which have each different ratio of the weight Wa of the fluorosilane compound A4 to the weight Wb of the fluorosilane compound B3 from one another, namely, 90/10, 80/20, 50/50, 30/70, 100/0, and 20/80 were also prepared and the stain-proofing layer was formed by using each of the fluorine-containing compositions S6.

In Experiment Example 6, the stain-proofing layer was formed by using a wet (dipping) method. Conditions were same as in Experiment Example 2.

### Experiment Example 7

By using a fluorine-containing composition S7, a stain-proofing layer was formed on the surface of the organic anti-reflection layer of the above-described workpiece. The fluorine-containing composition S7 which contained a fluorosilane compound A3 having a molecular weight of 1000 and a silane compound B3 having a molecular weight of 116.2 was prepared as a solution having a solid content concentration of 0.3% by being diluted with a fluorine type solvent (manufactured by Sumitomo 3M Limited; trade name: “Novec HFE-7200”). 6 types of fluorine-containing compositions S7 which have each different ratio of the weight Wa of the fluorosilane compound A3 to the weight Wb of the fluorosilane compound B3 from one another, namely, 90/10, 80/20, 50/50, 30/70, 100/0, and 20/80 were also prepared and the stain-proofing layer was formed by using each of the fluorine-containing compositions S7.

In Experiment Example 7, the stain-proofing layer was formed by using a wet (dipping) method. Conditions were same as in Experiment Example 2.

### Experiment Example 8

By using a fluorine-containing composition S8, a stain-proofing layer was formed on the surface of the organic anti-reflection layer of the above-described workpiece. The fluorine-containing composition S8 which contained a fluorosilane compound A having a molecular weight of 900 (hereinafter, referred to also as “compound A5”) and a silane compound B2 having a molecular weight of 652 was prepared as a solution having a solid content concentration of 0.3% by being diluted with a fluorine type solvent (manufactured by Sumitomo 3M Limited; trade name: “Novec HFE-7200”). 6 types of fluorine-containing compositions S8 which have each different ratio of the weight Wa of the fluorosilane compound A5 to the weight Wb of the fluorosilane compound B2 from one another, namely, 90/10, 80/20, 50/50, 30/70, 100/0, and 20/80 were also prepared and the stain-proofing layer was formed by using each of the fluorine-containing compositions S8.

In Experiment Example 8, the stain-proofing layer was formed by using a wet (dipping) method. Conditions were same as in Experiment Example 2.

### Experiment Example 9

By using a fluorine-containing composition S9, a stain-proofing layer was formed on the surface of the organic anti-reflection layer of the above-described workpiece. The fluorine-containing composition S9 which contained a fluorosilane compound A3 having a molecular weight of 1000 and a silane compound B having a molecular weight of 793.2 (manufactured by Shin-Etsu Chemical Co., Ltd.; trade name: “LS8980”) (hereinafter, referred to also as “compound B4”) was prepared as a solution having a solid content concentration of 0.3% by being diluted with a fluorine type solvent (manufactured by Sumitomo 3M Limited; trade name: “Novec HFE-7200”). 6 types of fluorine-containing compositions S9 which have each different ratio of the weight Wa of the fluorosilane compound A3 to the weight Wb of the fluorosilane compound B4 from one another, namely, 90/10, 80/20, 50/50, 30/70, 100/0, and 20/80 were also prepared and the stain-proofing layer was formed by using each of the fluorine-containing compositions S9.

In Experiment Example 9, the stain-proofing layer was formed by using a wet (dipping) method. Conditions were same as in Experiment Example 2.

### Experiment Example 10

By using a fluorine-containing composition S10, a stain-proofing layer was formed on the surface of the organic anti-reflection layer of the above-described workpiece. The fluorine-containing composition S10 which contained a fluorosilane compound A4 having a molecular weight of 10000 and a silane compound B4 having a molecular weight of 793.2 was prepared as a solution having a solid content concentration of 0.3% by being diluted with a fluorine type solvent (manufactured by Sumitomo 3M Limited; trade name: “Novec HFE-7200”). 6 types of fluorine-containing compositions S10 which have each different ratio of the weight Wa of the fluorosilane compound A4 to the weight Wb of the fluorosilane compound B4 from one another, namely, 90/10, 80/20, 50/50, 30/70, 100/0, and 20/80 were also prepared and the stain-proofing layer was formed by using each of the fluorine-containing compositions S10.

In Experiment Example 10, the stain-proofing layer was formed by using a wet (dipping) method. Conditions were same as in Experiment Example 2.

### Experiment Example 11

By using a fluorine-containing composition S11, a stain-proofing layer was formed on the surface of the organic anti-reflection layer of the above-described workpiece. The fluorine-containing composition S11 which contained a fluorosilane compound A having a molecular weight of 11000 (hereinafter, referred to also as “compound A6”) and a fluorosilane compound B2 having a molecular weight of 652 was prepared as a solution having a solid content concentration of 0.3% by being diluted with a fluorine type solvent (manufactured by Sumitomo 3M Limited; trade name: “Novec HFE-7200”). 6 types of fluorine-containing compositions S11 which have each different ratio of the weight Wa of the fluorosilane compound A6 to the weight Wb of the fluorosilane compound B6 from one another, namely, 90/10, 80/20, 50/50, 30/70, 100/0, and 20/80 were also prepared and the stain-proofing layer was formed by using each of the fluorine-containing compositions S11.

In Experiment Example 11, the stain-proofing layer was formed by using a wet (dipping) method. Conditions were same as in Experiment Example 2.

### Experiment Example 12

By using a fluorine-containing composition S12, a stain-proofing layer was formed on the surface of the organic anti-reflection layer of the above-described workpiece. The fluorine-containing composition S12 which contained a fluorosilane compound A6 having a molecular weight of 11000 and a silane compound B3 having a molecular weight of 116.2 was prepared as a solution having a solid content concentration of 0.3% by being diluted with a fluorine type solvent (manufactured by Sumitomo 3M Limited; trade name: “Novec HFE-7200”). 6 types of fluorine-containing compositions S12 which have each different ratio of the weight Wa of the fluorosilane compound A6 to the weight Wb of the fluorosilane compound B3 from one another, namely, 90/10, 80/20, 50/50, 30/70, 100/0, and 20/80 were also prepared and the stain-proofing layer was formed by using each of the fluorine-containing compositions S12.

In Experiment Example 12, the stain-proofing layer was formed by using a wet (dipping) method. Conditions were same as in Experiment Example 2.

### Experiment Example 13

By using a fluorine-containing composition S13, a stain-proofing layer was formed on the surface of the organic anti-reflection layer of the above-described workpiece. The fluorine-containing composition S13 which contained a fluorosilane compound A4 having a molecular weight of 10000 and a silane compound B having a molecular weight of 88.1 (manufactured by Shin-Etsu Chemical Co., Ltd.; trade name: “LS471”) (hereinafter, referred to also as “compound B5”) was prepared as a solution having a solid content concentration of 0.3% by being diluted with a fluorine type solvent (manufactured by Sumitomo 3M Limited; trade name: “Novec HFE-7200”). 6 types of fluorine-containing compositions S13 which have each different ratio of the weight Wa of the fluorosilane compound A4 to the weight Wb of the fluorosilane compound B5 from one another, namely, 90/10, 80/20, 50/50, 30/70, 100/0, and 20/80 were also prepared and the stain-proofing layer was formed by using each of the fluorine-containing compositions S13.

In Experiment Example 13, the stain-proofing layer was formed by using a wet (dipping) method. Conditions were same as in Experiment Example 2.

### Experiment Example 14

By using a fluorine-containing composition S14, a stain-proofing layer was formed on the surface of the organic anti-reflection layer of the above-described workpiece. The fluorine-containing composition S14 which contained a fluorosilane compound A3 having a molecular weight of 1000 and a fluorosilane compound B5 having a molecular weight of 88.1 was prepared as a solution having a solid content concentration of 0.3% by being diluted with a fluorine type solvent (manufactured by Sumitomo 3M Limited; trade name: “Novec HFE-7200”). 6 types of fluorine-containing compositions S14 which have each different ratio of the weight Wa of the fluorosilane compound A3 to the weight Wb of the fluorosilane compound B5 from one another, namely, 90/10, 80/20, 50/50, 30/70, 100/0, and 20/80 were also prepared and the stain-proofing layer was formed by using each of the fluorine-containing compositions S14.

In Experiment Example 14, the stain-proofing layer was formed by using a wet (dipping) method. Conditions were same as in Experiment Example 2.

### Experiment Example 15

By using a fluorine-containing composition S15, a stain-proofing layer was formed on the surface of the organic anti-reflection layer of the above-described workpiece. The fluorine-containing composition S15 which contained a fluorosilane compound A5 having a molecular weight of 900 and a fluorosilane compound B3 having a molecular weight of 116.2 was prepared as a solution having a solid content concentration of 0.3% by being diluted with a fluorine type solvent (manufactured by Sumitomo 3M Limited; trade name: “Novec HFE-7200”). 6 types of fluorine-containing compositions S15 which have each different ratio of the weight Wa of the fluorosilane compound A5 to the weight Wb of the fluorosilane compound B3 from one another, namely, 90/10, 80/20, 50/50, 30/70, 100/0, and 20/80 were also prepared and the stain-proofing layer was formed by using each of the fluorine-containing compositions SS.

In Experiment Example 15, the stain-proofing layer was formed by using a wet (dipping) method. Conditions were same as in Experiment Example 2.

### (Evaluation Method)

A cotton fabric was reciprocated 5000 times on a surface (convex surface) of a plastic lens on which the stain-proofing layer was formed by using the fluorine-containing composition in each of the above-described Experiment Examples under a load of 200 g and, then, a contact angle and wiping durability (scratch resistance) were evaluated. The results are shown in TABLE 1. as a whole.

The contact angle is a result of a measurement of a contact angle against pure water by a liquid drop method using a contact angle meter (manufactured by Kyowa Science Co., Ltd.; trade name: CA-D TYPE). Based on the results, water repellency of the stain-proofing layer can be evaluated. Evaluation criteria shown in TABLE 1. are as follows:

◯: 1000 or more;

Δ: from 90 to 1000; and

x: less than 90°.

In the wiping durability (scratch resistance), a lens surface was inspected visually and the results are shown in TABLE 1. with the following evaluation criteria:

◯◯: no scratch was found at all;

◯: 1 to 5 scratch lines were found;

Δ: 6 to 10 scratch lines were found; and

x: numerous scratches were found.

TABLE 1

| | | | Mixing | | | | | | | | | | | | | | | | | | |
|---|---|---|---|---|---|---|---|---|---|---|---|---|---|---|---|---|---|---|---|---|---|
| Fluorine- | A | B | ratio | 90/10 | | | 80/20 | | | 50/50 | | | 30/70 | | | 100/0 | | | 20/80 | | |
| containing | (molec- | (molec- | (Wa/Wb) | | Scratch | Overall | | Scratch | Overall | | Scratch | Overall | | Scratch | Overall | | Scratch | Overall | | Scratch | Overall |
| compo- | ular | ular | Coating | Contact | Resis- | evalua- | Contact | Resis- | evalua- | Contact | Resis- | evalua- | Contact | Resis- | evalua- | Contact | Resis- | evalua- | Contact | Resis- | evalua- |
| sition | weight) | weight) | method | angle | tance | tion | angle | tance | tion | angle | tance | tion | angle | tance | tion | angle | tance | tion | angle | tance | tion |
| S1 | A1 | B1 | Dry | ◯ | ◯ | ◯ | ◯ | ◯◯ | ◯◯ | ◯ | ◯◯ | ◯◯ | ◯ | ◯ | ◯ | ◯ | Δ | X | Δ | X | X |
| | (2500) | (497.5) | method | | | | | | | | | | | | | | | | | | |
| S2 | A1 | B1 | Wet | ◯ | ◯ | ◯ | ◯ | ◯◯ | ◯◯ | ◯ | ◯◯ | ◯◯ | ◯ | ◯ | ◯ | ◯ | Δ | X | Δ | X | X |
| | (2500) | (497.5) | method | | | | | | | | | | | | | | | | | | |
| S3 | A2 | B1 | Wet | ◯ | ◯ | ◯ | ◯ | ◯◯ | ◯◯ | ◯ | ◯◯ | ◯◯ | ◯ | ◯ | ◯ | ◯ | Δ | X | Δ | X | X |
| | (5000) | (497.5) | method | | | | | | | | | | | | | | | | | | |
| S4 | A3 | B2 | Wet | ◯ | ◯ | ◯ | ◯ | ◯ | ◯ | ◯ | ◯ | ◯ | ◯ | ◯ | ◯ | ◯ | Δ | X | Δ | X | X |
| | (1000) | (652) | method | | | | | | | | | | | | | | | | | | |
| S5 | A4 | B2 | Wet | ◯ | ◯ | ◯ | ◯ | ◯ | ◯ | ◯ | ◯ | ◯ | ◯ | ◯ | ◯ | ◯ | Δ | X | Δ | X | X |
| | (10000) | (652) | method | | | | | | | | | | | | | | | | | | |
| S6 | A4 | B3 | Wet | ◯ | ◯ | ◯ | ◯ | ◯ | ◯ | ◯ | ◯ | ◯ | ◯ | ◯ | ◯ | ◯ | Δ | X | Δ | X | X |
| | (10000) | (116.2) | method | | | | | | | | | | | | | | | | | | |
| S7 | A3 | B3 | Wet | ◯ | ◯ | ◯ | ◯ | ◯ | ◯ | ◯ | ◯ | ◯ | ◯ | ◯ | ◯ | ◯ | Δ | X | Δ | X | X |
| | (1000) | (116.2) | method | | | | | | | | | | | | | | | | | | |
| S8 | A5 | B2 | Wet | X | Δ | X | X | Δ | X | X | Δ | X | X | Δ | X | Δ | X | X | X | X | X |
| | (900) | (652) | method | | | | | | | | | | | | | | | | | | |
| S9 | A3 | Br | Wet | ◯ | Δ | X | ◯ | Δ | X | ◯ | Δ | X | ◯ | Δ | X | ◯ | Δ | X | Δ | X | X |
| | (1000) | (793.2) | method | | | | | | | | | | | | | | | | | | |
| S10 | A4 | B4 | Wet | ◯ | Δ | X | ◯ | Δ | X | ◯ | Δ | X | ◯ | Δ | X | ◯ | Δ | X | Δ | X | X |
| | (10000) | (793.2) | method | | | | | | | | | | | | | | | | | | |
| S11 | A6 | B2 | Wet | ◯ | Δ | X | ◯ | Δ | X | ◯ | Δ | X | ◯ | Δ | X | ◯ | X | X | Δ | X | X |
| | (11000) | (652) | method | | | | | | | | | | | | | | | | | | |
| S12 | A6 | B3 | Wet | ◯ | Δ | X | ◯ | Δ | X | ◯ | Δ | X | ◯ | Δ | X | ◯ | X | X | Δ | X | X |
| | (11000) | (116.2) | method | | | | | | | | | | | | | | | | | | |
| S13 | A4 | B5 | Wet | ◯ | Δ | X | ◯ | Δ | X | ◯ | Δ | X | ◯ | Δ | X | ◯ | Δ | X | Δ | X | X |
| | (10000) | (88.1) | method | | | | | | | | | | | | | | | | | | |
| S14 | A3 | B5 | Wet | ◯ | Δ | X | ◯ | Δ | X | ◯ | Δ | X | ◯ | Δ | X | ◯ | Δ | X | Δ | X | X |
| | (1000) | (88.1) | method | | | | | | | | | | | | | | | | | | |
| S15 | A5 | B3 | Wet | X | Δ | X | X | Δ | X | X | Δ | X | X | Δ | X | Δ | X | X | X | X | X |
| | (900) | (116.2) | method | | | | | | | | | | | | | | | | | | |

As is found from the evaluation results shown in TABLE 1., in examples in which stain-proofing layers were formed on the surfaces of the organic anti-reflection layers by using fluorine-containing compositions S1 to S7 which each contain a high molecular fluorosilane compound having a molecular weight of from 1000 to 10000 (first component) and a low molecular fluorosilane compound (second component), in cases in which the ratio of the weight Wa of the high molecular compound to the weight Wb of the low molecular compound is 90/10, 80/20, 50/50, or 30/70, the evaluations of the contact angle and the scratch resistance were favorable. Namely, in an example in which the stain-proofing layer was formed on the surface of the organic anti-reflection layer by using each of the fluorine-containing compositions S1 to S7, in a case in which the ratio of the weight Wa of the high molecular compound to the weight Wb of the low molecular compound is 90/10, 80/20, 50/50 or 30/70, the stain-proofing layer having sufficient durability can be formed. When the ratio of the weight Wa of the high molecular compound to the weight Wb of the low molecular compound is 80/20 or 50/50, evaluations of the contact angle and the scratch resistance after the durability test was performed were particularly favorable.

Further, as is found from Experiment Examples 1 and 2, so long as the fluorine-containing compositions in Experiment Examples 1 and 2 are used, the stain-proofing layer having sufficient durability can be formed on the organic anti-reflection layer by using either the dry method or the wet method. When the anti-reflection layer is formed by using the dry method, humidified annealing and dry annealing which are essential in the case of the wet method can be omitted and, then, cycle time can be reduced. Further, in the case of the wet method, since a solution for dipping is prepared, it is necessary to control a pot life of the solution; however, in the case of the dry method, since one piece of pellet is prepared and used as a depositing source for one time of film-making, there is a merit in that it is not necessary to control the pot life.

Further, although an example in which the substrate is the plastic lens has so far been explained, same effect can also be obtained with a glass lens. For example, in products in each of which the stain-proofing layer is provided on the organic anti-reflection layer, variety of products such as not only the spectacle lens but also various types of lens for, for example, cameras, other optical devices such as prism, recording media such as DVD and, further, window panes are included.

1. A production method, which is a production method for a product having a stain-proofing layer,
wherein, in the product, a lower layer of the stain-proofing layer is an organic anti-reflection layer; the production method comprises a step of forming the stain-proofing layer by using a fluorine-containing composition on a surface of the organic anti-reflection layer; and the fluorine-containing composition comprises at least one type of fluorosilane compound selected from the group consisting of fluorosilane compounds each having a molecular weight in the range of from 1000 to 10000 and at least one type of fluorosilane compound selected from the group consisting of fluorosilane compounds each having a molecular weight in the range of from 100 to 700.

2. The production method according to claim 1,
wherein a ratio of a weight Wa of at least one type of fluorosilane compound selected from the group consisting of fluorosilane compounds each having a molecular weight in the range of from 1000 to 10000 to a weight Wb of at least one type of fluorosilane compound selected from the group consisting of fluorosilane compounds each having a molecular weight in the range of from 100 to 700 satisfies the following condition:
90/10≧Wa/Wb≧30/70.

3. The production method according to claim 2,
wherein the ratio of the weight Wa to the weight Wb satisfies the following condition:
80/20≧Wa/Wb≧50/50.

4. The production method according to any one of claims 1 to 3,
wherein at least one type of fluorosilane compound selected from the group consisting of fluorosilane compounds each having a molecular weight in the range of from 1000 to 10000 comprises a fluorosilane compound represented by the following general formula (I) and/or a fluorosilane compound represented by the following general formula (II): 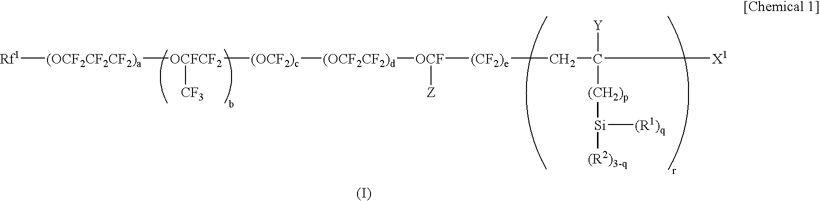
wherein Rf¹ represents a perfluoroalkyl group;
Z represents fluorine or a trifluoromethyl group;
a, b, c, d and e each independently represent an integer of 0, or 1 or more;
a+b+c+d+e represents at least 1, in which the order of respective repeating units represented by a, b, c, d and e is not particularly limited in the formula;
Y represents hydrogen or an alkyl group having from 1 to 4 carbon atoms;
X¹ represents hydrogen, bromine or iodine;
R¹ represents a hydroxyl group or a hydrolyzable substituent;
R² represents hydrogen or a monovalent hydrocarbon group;
p represents 0, 1 or 2;
q represents 1, 2 or 3; and
r represents an integer of 1 or more, 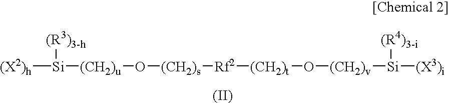
wherein Rf² represents a divalent group which comprises a unit represented by the formula:
-(CₖF₂ₖ)O—, (in the formula, k represents an integer of from 1 to 6) and a straight-chain perfluoropolyalkylene ether structure having no branch;
R³ and R⁴ each independently represent a monovalent hydrocarbon group having from 1 to 8 carbon atoms;
X² and X³ each independently represent a hydrolyzable group or a halogen atom;
s and t each independently represent an integer of from 0 to 2;
u and v each independently represent an integer of from 1 to 5; and
h and i each independently represent 2 or 3.

5. The production method according to claim 4,
wherein the organic anti-reflection layer comprises an organosilicon compound represented by the following general formula (III) and silica fine particles:
R⁵ₘR⁶ₙSiX⁴₄₋ₙ₋ₘ (III),
wherein R⁵ represents an organic group having a polymerizable reactive group;
R⁶ represents a hydrocarbon group having from 1 to 6 carbon atoms;
X⁴ represents a hydrolyzable group;
at least one of m and n represents 1 and the other represents 0 or 1.

6. A product, which is a product having a stain-proofing layer,
wherein a lower layer of the stain-proofing layer is an organic anti-reflection layer;
the stain-proofing layer is formed of a fluorine-containing composition; and
the fluorine-containing composition comprises at least one type of fluorosilane compound selected from the group consisting of fluorosilane compounds each having a molecular weight in the range of from 1000 to 10000 and at least one type of fluorosilane compound selected from the group consisting of fluorosilane compounds each have a molecular weight in the range of from 100 to 700.
